(19) United States
(12) Patent Application Publication
(10) Pub. No.: US 2010/0201497 A1
(43) Pub. Date: Aug. 12, 2010

(54) Electronic Tracking of Packages

(76) Inventor: Nika Jones, Minneapolis, MN (US)

Correspondence Address: MICHAEL PATRICK WIERSCH, 3750 PEACOCK CT #2, SANTA CLARA, CA, 95051, US

(21) Appl. No.: 12/704,388

(22) Filed: Feb. 11, 2010

Related U.S. Application Data
(60) Provisional application No. 61/151,667, filed on Feb. 11, 2009.

(51) Int. Cl. G06K 7/01

(52) U.S. Cl. 340/10.41

(57) ABSTRACT

Systems and methods for tracking packages are discussed herein. One embodiment of a method comprises receiving from a first radio-frequency tag at a first tracker a first tag information, receiving from a second radio-frequency tag at a second tracker a second tag information, receiving from the first tracker at the second tracker the first tag information and a first tracker information, and sending from the second tracker to a radio-frequency reader the first tag information, the first tracker information, the second tag information, and the second tracker information.

### RELATED APPLICATIONS

This application is related to and claims priority to commonly assigned copending Provisional U.S. Patent Application No. 61151667, titled “Electronic Addressing for Packages,” by Nika Jones, filed Feb. 11, 2009, which is incorporated by reference herein in its entirety.

### FIELD

Embodiments of the present invention relate in general to the field of tracking.

### BACKGROUND

Manual tracking of packages may be cumbersome. Some automated systems may be capital intensive and/or require heavy regulation. What is needed is a reliable, inexpensive approach to track packages.

### SUMMARY

Systems and methods for tracking packages are discussed. One embodiment of a method comprises receiving from a first radio-frequency tag at a first tracker a first tag information, receiving from a second radio-frequency tag at a second tracker a second tag information, receiving from the first tracker at the second tracker the first tag information and a first tracker information, and sending from the second tracker to a radio-frequency reader the first tag information, the first tracker information, the second tag information, and the second tracker information.

### BRIEF DESCRIPTION OF THE DRAWINGS

FIG. 1 illustrates a package with a transparent area, in accordance with embodiments.

FIG. 2 illustrates a backside of a package, in accordance with embodiments.

FIG. 3 illustrates a package with an embedded tracker, in accordance with embodiments.

FIG. 4 illustrates a tracker, in accordance with embodiments.

FIG. 5 illustrates a display, in accordance with embodiments.

FIG. 6 illustrates a block diagram of a tracking system for receiving radio frequency tag information, in accordance with embodiments.

FIG. 7 illustrates block diagrams of a tracking system for transferring data between trackers, in accordance with embodiments.

FIG. 8 illustrates a flow diagram of a tracking system, in accordance with embodiments.

### DESCRIPTION OF EMBODIMENTS

Reference will now be made in detail to various embodiments of the present invention, examples of which are illustrated in the accompanying drawings. While the present invention will be described in conjunction with the various embodiments, it will be understood that they are not intended to limit the invention to these embodiments. On the contrary, embodiments are intended to cover alternatives, modifications and equivalents, which may be included within the spirit and scope of the appended claims. Furthermore, in the following description of various embodiments, numerous specific details are set forth in order to provide a thorough understanding of embodiments. In other instances, well known methods, procedures, components, and circuits have not been described in detail as not to unnecessarily obscure aspects of the embodiments.

In the following description, numerous specific details are set forth to provide a thorough understanding. However, it will be recognized by one of ordinary skill in the art that embodiments may be practiced without these specific details. In other instances, well known methods, procedures, and components have not been described in detail as not to unnecessarily obscure aspects of the present invention.

The following description relates to the tracking of packages through a system which uses passive RFID tracking and/or low power short length radio waves to help locate coverage of a package route from a start to a finish independent of the route. The methods and systems use a tracker to store information along a route, and relay the information to other trackers. Some trackers report collected information at certain points along the route, thereby reducing an amount of reporting and/or a location or reporting. A user may use information obtained by the trackers to locate a package associated with a particular tracker.

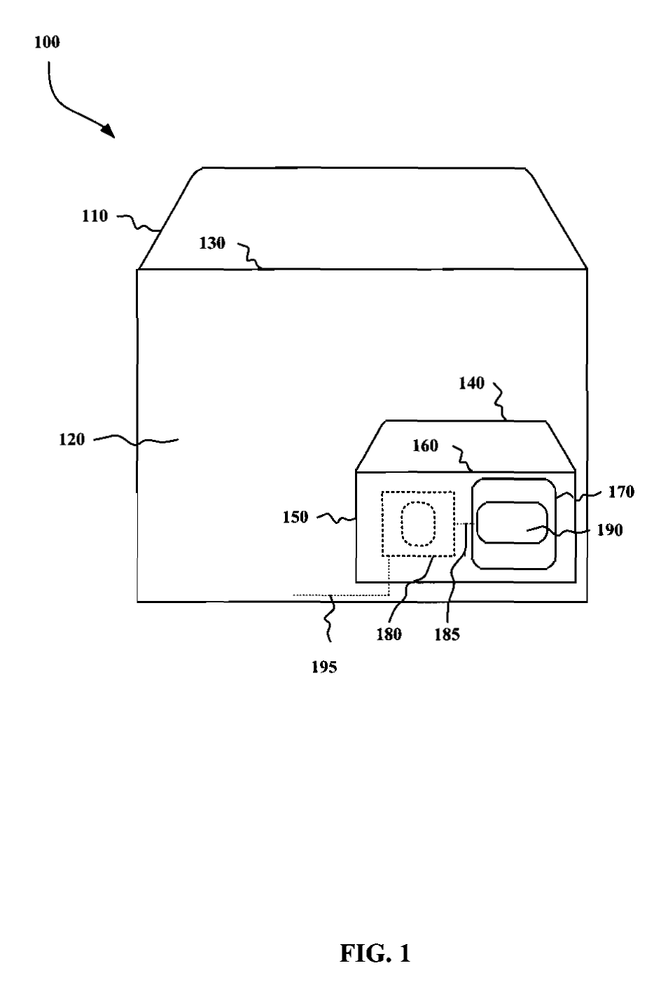

FIG. 1 illustrates a package 100 with a transparent area 170, in accordance with embodiments. The package 100 comprises a major compartment 120 and a minor compartment 150. In various embodiments, the package 100 may be any container or receptacle used for storage and/or transport. The package 100 may be transported and/or shipped via commercial, private, and/or government couriers. The package 100 may be used for transporting and/or shipping major compartment contents (not depicted), such as luggage, a shipping container, an envelope, and the like. The major compartment 120 contents may be paper articles, such as letters, and/or non-paper articles, such as computer storable media, and/or any other material that may be shipped.

The major compartment 120 seals contents within the major compartment 120 by folding a flap 110 at a crease 130. The minor compartment 150 seals minor component contents by folding a flap 140 at a crease 160. In one embodiment, the minor compartment 150 is attached to the major compartment 120. Mechanisms to attach the flap 110 to the major compartment 120, the flap 140 to the minor compartment 150, and the minor compartment 150 to the major compartment 120 may be glue, paste, adhesive, rigid and/or semi-rigid materials, such as Velcro, and the like.

In one embodiment, the minor compartment 150 is physically larger than the major compartment 120 (not depicted). In another embodiment, the minor compartment 150 has a larger volume for storage than the major compartment 120.

In one embodiment, the minor compartment 150 is inserted into another package (not depicted). In another embodiment, the minor compartment 150 is detached from the major compartment 120. In one embodiment, the minor compartment 150 is located within an interior (not depicted) of the major compartment 120.

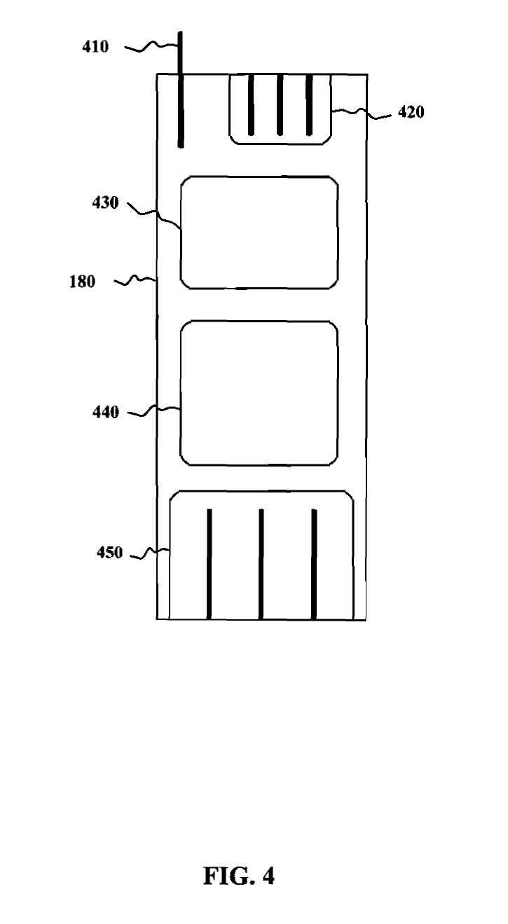

The minor compartment 150 supports a tracker, such as a tracker 180. A tracker and a tracking device are used interchangeable. The tracker has electronic mechanisms, such as memory, a display 190, and an antenna 195. The display 190 is coupled to the tracker 180 via connection 185. The dotted lines of the connection 185, the tracker 180, and the antenna 195 represent items that are viewed from the outside. The tracker is further discussed herein. The antenna 195 may be a antenna. The electronic mechanisms are further discussed herein and with regard to FIG. 4.

In one embodiment, the minor compartment 150 comprises a transparent area 170. The transparent area 170 is configured to permit observation of a tracker within the minor compartment 150, while providing a protective cover for any contents within the minor compartment 150. In one embodiment, material used for the transparent area 170 is of a heavy plastic construction around the electronic mechanisms, thereby allowing the electronic mechanisms to withstand reasonable abuse.

In one embodiment, the package 100 when used to carry documents allows for addressing information to be displayed within the address display area by obtaining information from the tracker 180. The same information or different information from the tracker 180 may be related via radio frequency through the antenna 195 or transferred via physical contact through the transparent area 170. The transparent area 170 may comprise a smart card hole, wherein the smart card hole is large enough for an entire smart card to be read.

In one embodiment, the major compartment 120 has a width and/or dimensions within ten percent of the minor compartment 150. In another embodiment, the major compartment 120 and the minor compartment 150 are of different sizes, up to one hundred times in size, as to allow flexibility for transferring different sized packages. For example, the major compartment 120 is large enough to transfer a couch. In another embodiment, the major compartment 120 is a piece of luggage (not depicted).

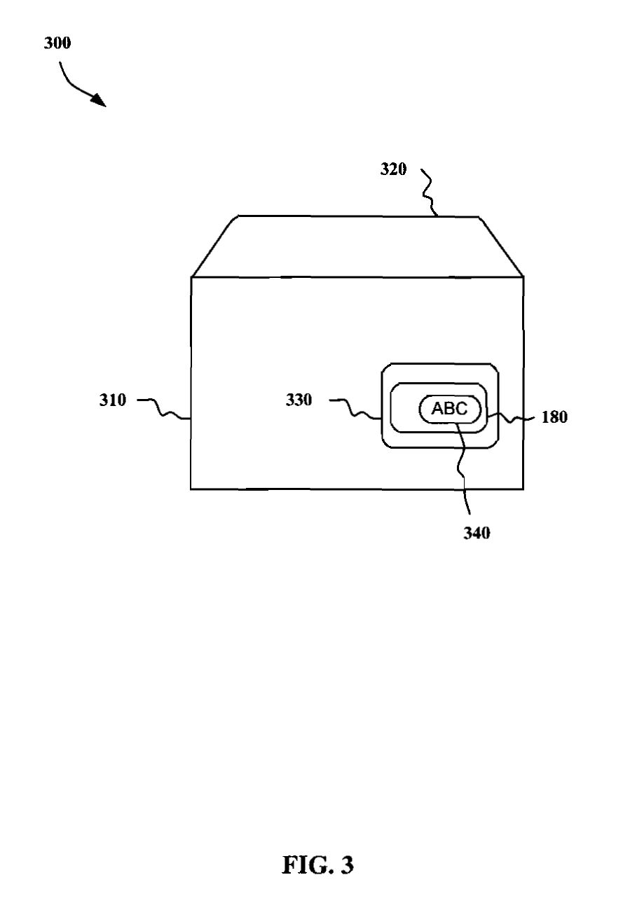

In another embodiment, the minor compartment 150 comprises a translucent material and/or opaque material, wherein information is transferred via the antenna 195 and/or a visual display, such as display 190, of the tracker 180. In one embodiment, the tracker 180 is configured to respond to any radio-frequency signals received by the antenna 195. The display is discussed further with regard to FIG. 3 and herein.

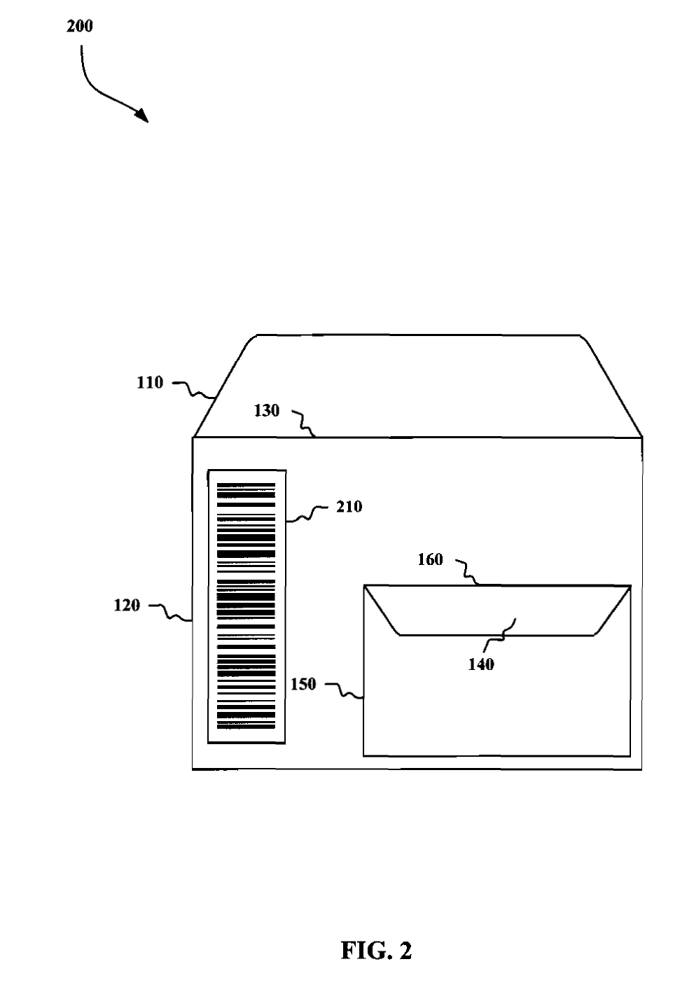

FIG. 2 illustrates a backside of a package 100, in accordance with embodiments. The backside comprises an address area 210. The address area 210 may be of any conventional addressing technologies standard in the industry, such as a barcode. In one embodiment, the minor compartment 150 is attached to the backside of the package 100.

FIG. 3 illustrates a package 300 with an embedded tracker, in accordance with embodiments. The package 300 comprises a compartment 310, a flap 320, and an optional display area 330. In one embodiment, the tracker 180 has a visual display 340. The visual display 340 may be a liquid crystal display, a light emitting diode, and the like. The visual display 340 may display alpha-numeric characters, such as “ABC”, other characters, such as “*=B@”, non-English language characters, and the like. In one embodiment, the visual display 340 displays tracker identification similar to information that is transmitted by the tracker. In one embodiment, the information displayed is an address. In various embodiments, the information displayed comprises messages and/or notes indicating handling instructions, contents of the package, such as the package 100, if there are any other packages associated with this package, and the like. Tracker identification and transmission is further discussed herein.

FIG. 4 illustrates a tracker 180, in accordance with embodiments. The tracker 180 comprises an antenna device 410, an optional data interface 420, a memory 430, a power source 440, and an optional display interface 450. The antenna device 410 may be an antenna, an antenna/extender, and/or any device used to transmit and/or receive radio-frequency signals. In one embodiment, the antenna/extender couples to an antenna embedded within the package.

The data interface 420 may be a smart card contact and/or a universal-serial bus (“USB”). The memory 430 may be flash memory, random access memory, read-only memory, and the like, or any other memory used in the industry. The power source 440 may be a battery, and the like, or any other mobile power source used in the industry. The optional display interface 450 is any interface that may be coupled to a display, such as display 190.

In one embodiment, the display 190 may be read and/or coupled though a transparent area and/or a hole located in the minor compartment 150 and/or package 300. In various embodiments, the data interface 420 may be coupled though a hole located in the minor compartment 150 and/or accessible via the flap 140, and the like.

In one embodiment, the tracker 180 comprises a removable electronic flash memory device, such as memory 430. The flash memory device comprises a male USB interface and/or a smart card interface, such as data interface 420. The flash memory device may hold data about the tracking, routing and origin of the device. In various embodiments, the USB interface may be used to add and remove tracking data to the device. In various embodiments, the USB interface may be used to power an e-paper screen, as is discussed herein and with regard to FIG. 4. The smart card interface may be used to read origin and accounting information. In various embodiments, the smartcard interface may hold different data than data on the memory 430 in the tracker 180.

In one embodiment, the tracker 180 attaches to a standard USB type-A port. The memory 430 may store tracker identification, tracking, routing, destination and/or origination data, and similar data from other trackers, and from radio frequency tags.

The data stored in the memory 430 may be compressed and/or encrypted. In one embodiment, a size of the minor compartment allows for snug fit of the USB type-A port and/or the tracker 180. In one embodiment, the identification uniquely defines one tracker from another tracker.

In one embodiment, the construction details of the device are standard in the industry. The height of the tracker 180 may range from millimeters to several centimeters.

In one embodiment, the tracker 180 comprises a radio frequency tag. In one embodiment, the tracker 180 and the antenna 195 are removable from the package, allowing for easy access and/or replacement.

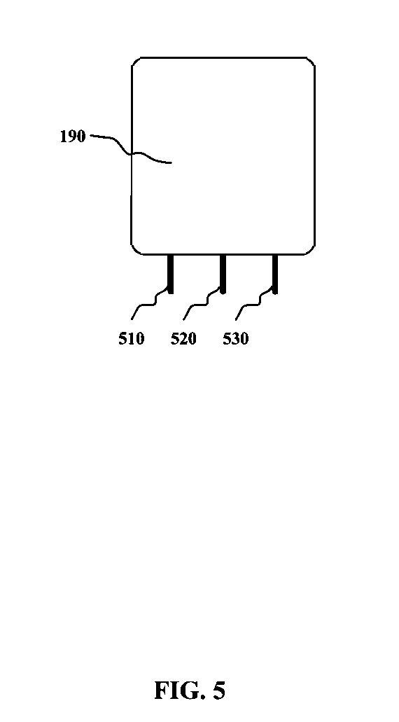

FIG. 5 illustrates a display 190, in accordance with embodiments. The display 190 comprises connections, such as connections 510, 520, and 530. The connections provide data to the display 190. In one embodiment, the display 190 has data recorded visually, and no additional power is needed. In one embodiment, the display 190 is similar (within five percent) of the size of the package, such as the minor compartment 150 or the compartment 310. In another embodiment, the display 190 is small and just large enough to display necessary information, such as one inch by one-quarter inch. The size may be of any size that is manufactured. In one embodiment, the display may provide additional information for a delivery or value of contents of a package within the package, such as the major compartment 120. In one embodiment, the display 190 is an electronic paper display.

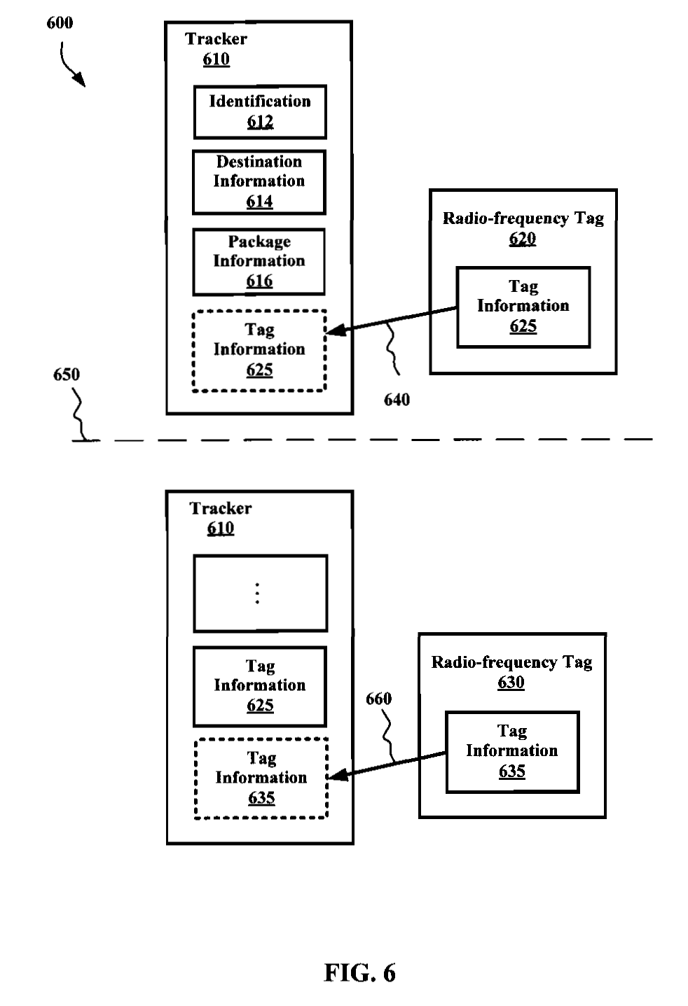

FIG. 6 illustrates a block diagram of a tracking system 600 for receiving radio frequency tag information, in accordance with embodiments. The tracking system 600 comprises a tracker 610, a radio frequency tag 620, and a radio frequency tag 630. The dotted line 650 indicates a time and distance lapse, as discussed herein.

The tracker 610 comprises a memory device to store information, such as identification 612, a destination information 614, and a package information 616, and information received from the radio frequency tag 630, as indicated by arrow 640, such as tag information 625, as indicated by the dotted box. The tracker 610 may also store additional information from other trackers, as discussed herein.

A radio frequency tag may be a RFID tag, ZigBee, and the like, or any other low power transmission device/protocol.

The identification, such as identification 612, may be an 8-bit, 16-bit, 32-bit, and the like, and may be encrypted and encoded. In one embodiment, the destination information, such as destination information 614, is a final destination. In another embodiment, the destination information is a leeway and/or route. The package information, such as the package information 616, describes and/or characterizes the package or contents of the package 100. The tag information, such as tag information 625, is information transmitted by the radio frequency tag, such as the radio frequency tag 620. In one embodiment, the tag information is location information of the radio frequency tag, for example, “NEW YORK”. The tag information may be descriptive, for example warehouse 1, or may be a key, for example “8VX4R”.

The information of the tracker 610 is stored in memory, such as used by the industry. In one embodiment, contents of the tracker memory may be erased after the tracker reaches a final destination.

In one embodiment, the radio frequency tag continuously broadcasts tag information. In another embodiment the radio frequency tag is transmitted periodically and/or changes frequency during different periods. In another embodiment, the radio frequency tag and a tracker establish communication via a handshake.

In one embodiment, the RF tag is active, that is it has a power source to power a signal. In another embodiment, the RF tag is passive, that is the RF tag does not have a power source and used a request from a tracker to send a signal. In one embodiment, the RF tag establishes a communication with the tracker.

In one embodiment, the dotted line 650 represents a transmission separation between two radio frequency tags, so as a tracker can only receive one radio frequency tag transmission at any specific location. In another embodiment, the dotted line 650 separates a great distance, such as between airports.

Below the dotted line 650 illustrates the tracker 610 receiving a second radio frequency tag signal, via arrow 660, that is tag information 635. In one embodiment, the tracker 610 stores tag information 635 in sequence with tag information 625, so as to be able to transmit tag information in sequence.

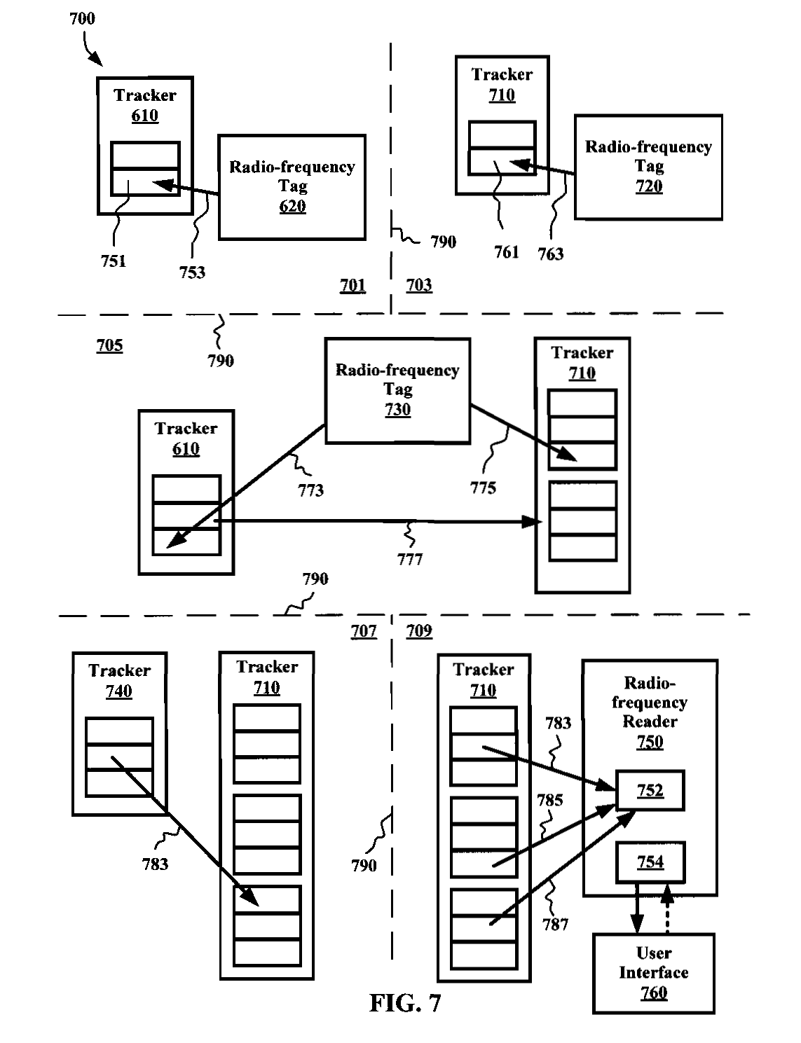

FIG. 7 illustrates block diagrams of a tracking system 700 for transferring data between trackers in different phases 701, 703, 705, 707, 709, in accordance with embodiments. The phases 701, 703, 705, 707, 709 are separated by the dotted lines 790. In one embodiment, the phases 701, 703, 705, 707, 709 are in time sequential order, that is the phases follow the sequence of 701, 703, 705, 707, and 709. In another embodiment, the phases are not in a sequential order, for example, they occur in a real time sequence as 703, 701, 707, 705, 709, and the like.

The system 700 comprises a tracker 610, a tracker 710, a tracker 740, a radio frequency tag 620, a radio frequency tag 720, a radio frequency tag 730, a radio frequency reader 750, and a user interface 760. The radio frequency reader 750 comprises a memory 752 and a communications device 754. In one embodiment, the radio frequency reader 750 is a radio frequency identification reader.

In phase 701, the tracker 610 receives tag information, via line 753, from the radio frequency tag 620, and stores the tag information in memory 751, as discussed in FIG. 6 and herein. Similarly, in phase 702, the tracker 710 receives tag information, via line 763, from the radio frequency tag 720, and stores the tag information in memory 761.

In phase 705, the tracker 610 and the tracker 710 both receive tag information from radio frequency tag 730 as indicated by arrows 773 and 775. The tracker 710 is determined to be an authority tracker, as discussed herein, and receives a transmission from the tracker 610 containing some and/or all the information in memory of the tracker 610, as indicated by arrow 777. The tracker 710 stores the information from the tracker 610 in memory.

In phase 707, the tracker 740 sends information contained in memory to the tracker 710, as indicated by arrow 783. In one embodiment, the tracker 740 is determined to the authority tracker and receives information from tracker 710.

In phase 709, the tracker 710 transmits some and/or all the information obtained from other trackers and/or obtained first hand from radio frequency tags to the radio frequency reader 750, as indicated by arrows 783, 785, and 787. The radio frequency reader 750 transmits the information to the user interface 760.

The transmission to the user interface 760 may be a transfer of some or all the information stored in the memory 752 via the communications device 754. In one embodiment, the information received from the radio frequency reader 750 is used to track the trackers in the system. In one embodiment, the information received from the radio frequency reader 750 is used to locate a specific package associated with a particular tracker.

In one embodiment, the system 700 comprises multiple transit stages, trackers, radio frequency tags and radio frequency readers to provide a network to access trackers across a state, a nation, and/or internationally.

In one embodiment, the system 700 uses stages such as an identification stage, a transportation/storage stage, and a destination/transfer stage.

In one embodiment, a tracker stores information as a hashed function. In one embodiment, after a location of another tracker is received by an authority tracker, the authority tracker sends the information to the next radio frequency reader for prompt processing.

In one embodiment, a tracker may communicate with other trackers. If there are multiple trackers, one tracker may be determined to be an authority tracker. The authority tracker is a tracker that collects other tracker information from other trackers, and sends the other tracker information to radio frequency readers. In one embodiment, the other tracker information is information initially collected and/or stored on a different tracker. For example, tracker 710 has stored information, and sends the stored information to the tracker 740, thereby designating with the tracker 740 to have other tracker information related to tracker 710. Other tracker information may include similar information obtained by the tracker receiving the other tracker information, such as radio frequency tag information, tracker identification, and the like. The tracker identification uniquely identifies each tracker. The authority tracker is authorized to transmit information regarding tracker identification, the radio frequency tag information received first hand, and other tracker information. In one embodiment, a tracker does not broadcast other tracker information until the tracker is elected, determined and/or becomes an authority tracker. In one embodiment, the authority tracker broadcasts, transmits, and/or sends information periodically. In another embodiment, the authority tracker sends information continuously. In one embodiment, the authority tracker sends information at scheduled intervals per a table or some other approach. For example, the authority trackers sends information every five minutes between 18:00 and 21:00 and every twenty minutes outside of the range.

In one embodiment, the authority tracker stores the other information received first hand in a same memory location. In another embodiment, the authority tracker stores the other information received first hand in a different memory location than the other tracker information.

In one embodiment the authority tracker collects other tracker information from other authority trackers.

In one embodiment, a tracker is promoted to an authority tracker is there are no other authority trackers within a radio-frequency range.

The authority-tracker may be determined in a number of different ways, such as highest battery life, a priority assignment of devices, a pre-determined hierarchy, and the like. In various embodiments, an authority-tracker may delegate the authority to another device. In another embodiment, an authority tracker may be elected if multiple trackers have one segment of a route, whereby after a segment is completed, different authority-trackers may be elected on any continuing segments of the route.

In one embodiment, a sub-authority tracker stores some or all of the information of the authority tracker. A sub-authority tracker may be used as a backup.

In one embodiment, the sub-authority has a different route as the authority tracker. After the sub-authority tracker and the authority tracker are out of radio frequency range, the sub-authority may become the authority.

In one embodiment, after one or more authority trackers are established, the one or more authority trackers coordinate multiple packages and/or trackers with similar routes as an associated route and/or partial route group, thereby reducing a number of actual trackers that are monitored.

After data is received at a user interface, a processing center may relay package information to different locations. For example, if a package gets misplaced, information may be relayed to an authority to address the misplacement. Package information may be used to realign the package destination, bring attention to a lost or misplaced package, regroup the package, alert the originating and receiving ends or package locations, and the like.

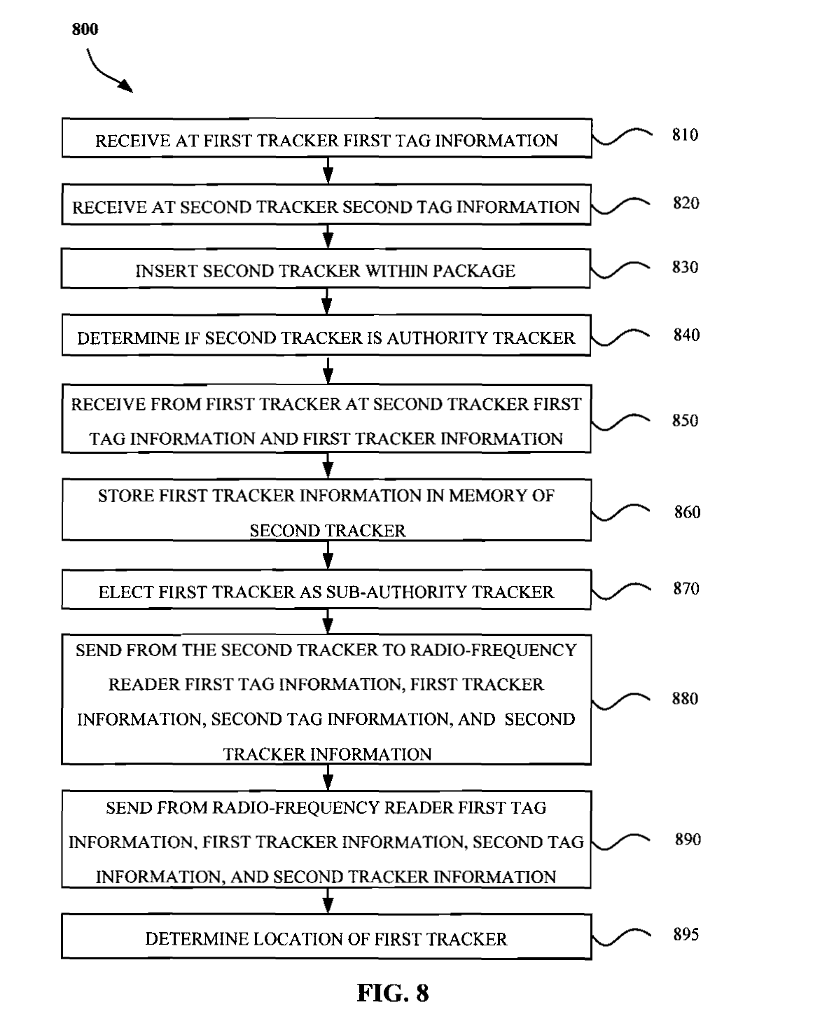

FIG. 8 illustrates a flow diagram of a tracking system, in accordance with embodiments. In step 810, a first tracker, such as the tracker 610, receives a first tag information sent from a first RF tag, such as RF tag 720. The tag information may be location information as discussed herein. In step 820, a second tracker, such as tracker 710, receives a second tag information from a second RF tag, such as RF tag 720.

In step 830, the second tracker is inserted into a package, such as package 100. The insertion of the tracker may take place before or after the tracker reads a RF tag. In one embodiment, a tracker associated with a package may be replaced with another tracker after transferring any necessary information.

In step 840, the second tracker is determined to be an authority tracker as discussed herein. In step 850, the second tracker receives from the first tracker the first tag information and the first tracker information, as discussed herein. In step 860, the second tracker stores the information received from the first tracker. In step 870, the first tracker is elected as a sub-authority.

In step 880, the second tracker sends to a radio-frequency reader the first tag information, the first tracker information, the second tag information, and the second tracker information. In one embodiment, the second tracker sends information requested by the RF reader. In another embodiment, the second tracker sends only information that is contemporary, such as information obtained within the last two hours. In another embodiment, the second tracker sends selected information, for example, information that was received from other trackers and does not send information that was directly received from RF tags.

In step 890, the RF reader sends information, such as the first tag information, the first tracker information, the second tag information, the second tracker information, and any other tracker information, the reader may have. In one embodiment, a user requests information regarding specific a package and/or tracker, and in response the RF reader sends the information. In step 895, a user determines the location of a specific package and/or tracker based on information sent from the RF reader. In one embodiment, a user determines a location of a package, based on receiving information directly from one or more trackers.

Various alternatives, modifications, and equivalents may also be used. For example, information may be used to determine if a package should be returned to the sender, due to a missed payment or damages occurred during transit. Therefore, the above description should not be taken as limiting the scope of the invention which is defined by the appended claims.

While the invention is described in conjunction with various embodiments, it is understood that they are not intended to limit the invention to these embodiments. On the contrary, the invention is intended to cover alternatives, modifications and equivalents, which may be included within the spirit and scope of the invention as defined by the appended claims.

What is claimed is:

1. A method comprising
receiving from a first radio-frequency tag at a first tracker a first tag information;
receiving from a second radio-frequency tag at a second tracker a second tag information;
receiving from the first tracker at the second tracker the first tag information and a first tracker information; and
sending from the second tracker to a radio-frequency reader the first tag information, the first tracker information, the second tag information, and the second tracker information.

2. The method of claim 1, prior to the sending from the second tracker, further comprising determining if the second tracker is an authority tracker.

3. The method of claim 2, further comprising electing the second tracker as the authority tracker from a group of one or more trackers within communication of each of the one or more trackers.

4. The method of claim 2, further comprising selecting the second tracker as the authority tracker.

5. The method of claim 2, further comprising changing the first tracker from an authority tracker to a non-authority tracker.

6. The method of claim 2, further comprising storing the first tracker information in memory of the second tracker.

7. The method of claim 2, further comprising electing the first tracker as a sub-authority tracker.

8. The method of claim 1, further comprising inserting the second tracker within a package, wherein the second tracker is at least partially viewable from outside of the package through a transparent area of the package.

9. The method of claim 1, further comprising sending from the radio-frequency reader the first tag information, the first tracker information, the second tag information, and the second tracker information.

10. The method of claim 9, further comprising determining a location of the first tracker based the sending of the first tag information and the first tracker information.

11. The method of claim 9, further comprising determining a location of the first tracker based the sending of the first tracker information, wherein the tracker information comprises destination information of the first tracker.

12. A system comprising:
a first tracker configured to receive a first tag information from a first radio-frequency tag, to transmit the first tag information, to transmit first tracker information;
a second tracker configured to receive a second tag information from a second radio-frequency tag, to receive the first tag information from the first tracker, to transmit the second tag information, to transmit a second tracker information, to switch on-and-off an authority status, and if the authority status is switched on, to transmit the first tag information and the first tag information; and
an radio frequency reader configured to receive from the second tracker the first tracker information, the first tag information, the second tracker information, and the second tag information.

13. The system of claim 12, wherein the first tracker information comprises a first tracker destination information, and a first tracker identification, wherein the first tracker identification is unique to the first tracker; and wherein the second tracker information comprise a second tracker destination information, and a second tracker identification, wherein the second tracker identification is unique to the second tracker.

14. The system of claim 12,
wherein the first tracker comprises a first time recording device, wherein the first time recording device is configured to record a time when the first tag information is received, and
wherein the second tracker comprises a second time recording device, wherein the second recording device is configured to record a time when the second tag information is received.

15. The system of claim 14,
wherein the first recording device is further configured to record a time when the first tracker receives the second tracker information; and
wherein the second recording device is further configured to record a time when the second tracker receives the first tracker information.

16. The system of claim 12, wherein the first location and the second location are separated by a distance of at least ten miles.

17. The system of claim 12, wherein the second tracker operates as an authority tracker via an election between the first tracker and the second tracker.

18. The system of claim 12, wherein the second tracker operates as an authority tracker via a user selection.

19. A system comprising:
a first tracker configured to receive a first tag information from a first radio-frequency tag, to transmit the first tag information, to transmit a first identification, wherein the first identification is unique to the first tracker, to transmit the first destination information, to switch on-and-off an authority status;
a second tracker configured to receive a second tag information from a second radio-frequency tag, to receive the first tag information from the first tracker, to transmit the second tag information, to transmit a second tracker information, to switch on-and-off an authority status; and
a radio frequency reader configured to receive from the first destination information, the first tag information, the second destination information, and the second tag information.

20. The system of claim 19, wherein if the authority status is switched on, to transmit the first tag information, the second tag information, the first tracker information, and the second tracker information.
